(19) United States
(12) Patent Application Publication
(10) Pub. No.: US 2024/0196090 A1
(43) Pub. Date: Jun. 13, 2024

(54) IMAGE-CAPTURING SYSTEM AND METHOD THEREOF

(71) Applicant: GEATER SHINE LIMITED, APIA (WS)

(72) Inventor: YI-PIN CHANG, HSINCHU CITY (TW)

(21) Appl. No.: 18/063,920

(22) Filed: Dec. 9, 2022

(51) Int. Cl. H04N 23/67; G06F 3/01; G06F 3/0488; G06F 3/16; G06T 5/50; G06T 7/20; G06T 7/50; G06V 20/70

(52) U.S. Cl. CPC H04N 23/675; G06F 3/013; G06F 3/0488; G06F 3/167; G06T 5/50; G06T 7/20; G06T 7/50; G06V 20/70; G06T 2207/20221; G06V 2201/07

(57) ABSTRACT

The present application discloses an image-capturing system including a first image-sensing module, a second image-sensing module, a processor, and a display panel. The first image-sensing module senses a scene that a user is photographing. The processor detects objects in the scene and attaches labels to the detected objects. The display panel displays a preview image of the sensed scene with the labels of the detected objects for the user to select. The first image-sensing module further tracks and focuses on a first object selected by the user to capture a first image, and the second image-sensing module tracks and focuses on a second object selected by the user to capture a second image. The processor further fuses the first and second images into a resulting image in which the first and the second objects are in focus.

### TECHNICAL FIELD

The present disclosure relates to an image-capturing system and a method thereof, and more particularly, to an image-capturing system and a method for tracking and focusing on at least two objects.

### DISCUSSION OF THE BACKGROUND

In a photo or a video, the subject can be presented in or out of focus depending on a user's purposes. A sharp subject in the photo may attract a viewer's attention. Furthermore, the sharp subject may be stands out more if others are blurred. In some situations, the user may wish to bring multiple subjects (or objects) into focus. However, based on optical principles, only one subject at a time can be focused on by a camera. Therefore, finding a way to achieve multi-focusing is an important issue in this field.

### SUMMARY

One embodiment of the present disclosure discloses an image-capturing system including a first image-sensing module, a second image-sensing module, a processor, and a display panel. The first image-sensing module is configured to sense a scene that a user is photographing. The processor is configured to detect objects in the scene sensed by the first image-sensing module and attach labels to the detected objects. The display panel is configured to display a preview image of the sensed scene with the labels of the detected objects for the user to select. The first image-sensing module is further configured to track and focus on a first object of the detected objects selected by the user to capture a first image, and the second image-sensing module is configured to track and focus on a second object of the detected objects selected by the user to capture a second image. The processor is further configured to fuse the first image and the second image into a resulting image in which the first and the second objects are in focus.

Another embodiment of the present disclosure discloses an image-capturing method including steps of: sensing a scene being photographed; detecting a plurality of objects in the sensed scene; attaching a plurality of labels to the detected objects; displaying a preview image of the sensed scene with the labels of the detected objects on a display panel; selecting a first object from the detected objects; tracking and focusing on the first object to capture a first image; selecting a second object from the detected objects; tracking and focusing on the second object to capture a second image; and fusing the first image and the second image into a resulting image in which the first and the second objects are in focus. The first image and the second image are captured at substantially a same instant.

Since the image-capturing system and the image-capturing method provided by embodiments of the present disclosure can track and focus on more than one object in a scene, an image/video having more than one object in focus can be generated and displayed in real time.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures.

FIG. 1 shows a schematic illustration of an image-capturing system according to some embodiments of the present disclosure.

FIG. 2A, FIG. 2B, and FIG. 2C show preview images with labels of objects according to some embodiments of the present disclosure.

FIG. 3 illustrates a fusion operation which is performed to fuse a first image and a second image into a resulting image according to some embodiments of the present disclosure.

FIG. 4 shows a schematic illustration of an image-capturing system according to other embodiments of the present disclosure.

FIG. 5 shows a flow chart of an image-capturing system according to some embodiments of the present disclosure.

### DETAILED DESCRIPTION

The following description accompanies drawings, which are incorporated in and constitute a part of this specification, and which illustrate embodiments of the disclosure, but the disclosure is not limited to the embodiments. In addition, the following embodiments can be properly integrated to complete another embodiment.

References to “one embodiment,” “an embodiment,” “exemplary embodiment,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

In order to make the present disclosure completely comprehensible, detailed steps and structures are provided in the following description. Obviously, implementation of the present disclosure does not limit special details known by persons skilled in the art. In addition, known structures and steps are not described in detail, so as not to unnecessarily limit the present disclosure. Preferred embodiments of the present disclosure will be described below in detail. However, in addition to the detailed description, the present disclosure may also be widely implemented in other embodiments. The scope of the present disclosure is not limited to the detailed description, and is defined by the claims.

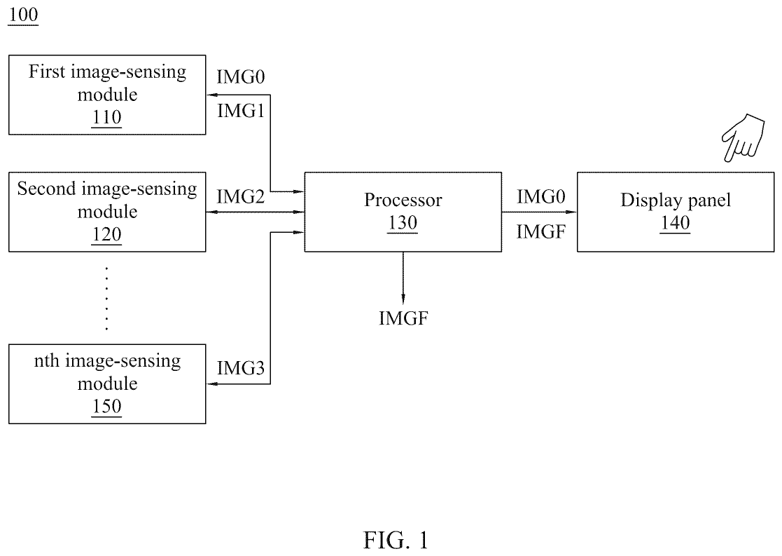

FIG. 1 shows an image-capturing system 100 according to some embodiments of the present disclosure. The image-capturing system 100 is configured to generate a resulting image IMGF which shows at least two subjects (objects of interest) in focus. In some further embodiments, the image-capturing system 100 is further configured to generate a video showing at least two objects of interest being tracked in focus.

When a scene that a user is photographing includes several objects having different distances from a camera, the camera normally can track and focus only on a single object in the scene. Therefore, when there is a need to focus on another object in the scene, further image post-processing is required to make the other object clear and in focus. Usually, the image post-processing is performed after the original image has been taken. Such approaches cannot obtain and display the desired result in real time.

The image-capturing system 100 of the present disclosure is able to track and focus on at least two objects of interest in the scene at substantially the same instant. Furthermore, the image-capturing system 100 can further display the real-time image and/or a real-time video which includes multiple focused objects for a user's preview.

In some embodiments, the image-capturing system 100 is implemented on a mobile phone or a dashboard camera.

The image-capturing system 100 includes a first image-sensing module 110, a second image-sensing module 120, a processor 130, and a display panel 140.

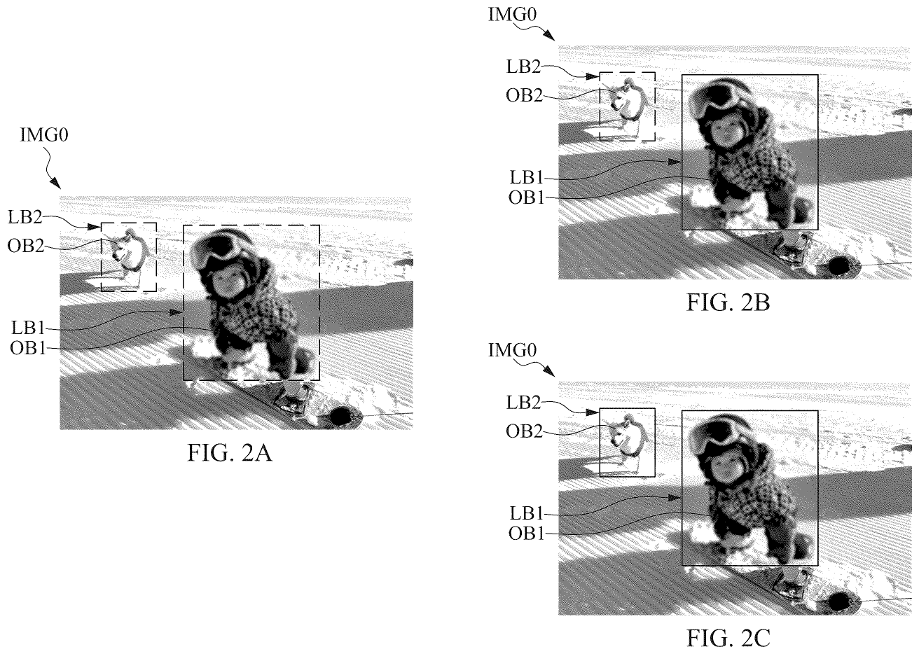

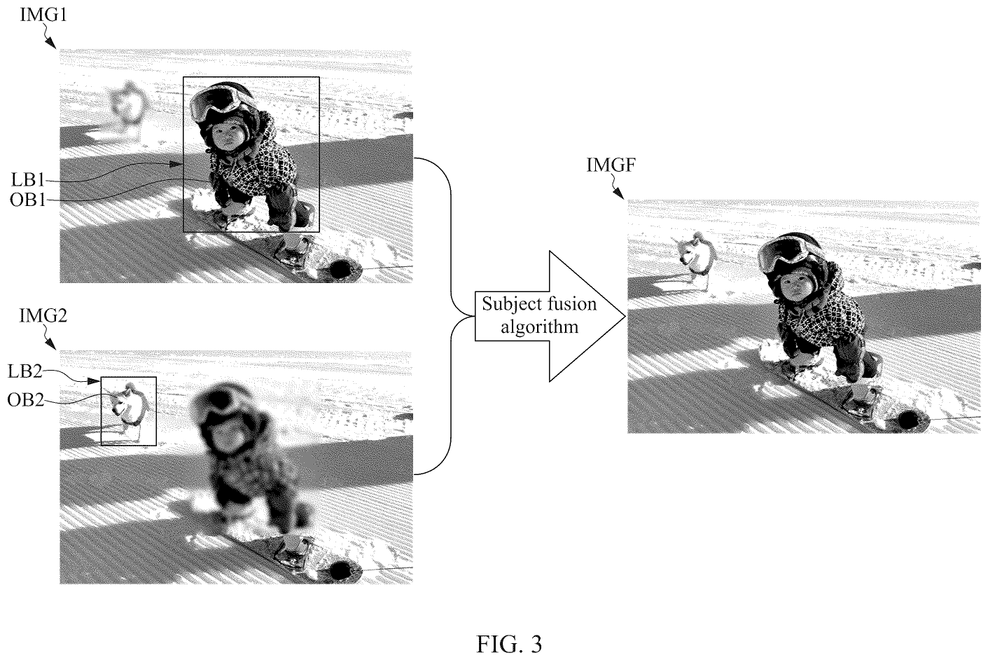

With reference to FIG. 1 together with FIGS. 2A-2C, and FIG. 3, the first image-sensing module 110 is configured to sense a scene that a user is photographing. The processor 130 is configured to detect objects shown in the sensed scene. The processor 130 may further attach labels to the detected objects so as to allow the user to be aware of the detected objects. The display panel 140 is configured to display a preview image IMG0 of the sensed scene with the labels of the detected objects for the user to select. For example, as shown in FIG. 2A, the objects OB1 and OB2 are detected by the processor 130 and the labels LB1 and LB2 are attached to the detected objects OB1 and OB2, respectively, in the preview image IMG0. However, the number of objects and labels shown in FIG. 2A is provided for illustrative purposes and is not intended to be limiting. It should be appreciated that the scene may include more objects. In addition, although the objects OB1 and OB2 shown in FIG. 2A are a child and a dog, respectively, the present disclosure is not limited thereto. It should be appreciated that the processor 130 can detect any distinguishable object in the scene.

In some embodiments, the processor 130 includes an artificial intelligence (AI) processing unit, and the AI processing unit is configured to detect the objects in the preview image IMG0 of the sensed scene according to a machine learning model.

In some embodiments, the display panel 140 may further display the preview image IMG0 with a highlighted label if any object has been selected. Specifically, the user can select at least one object of interest from the detected objects OB1 and OB2. Before the selection, the labels LB1 and LB2 are represented by dashed-line boxes (as shown in FIG. 2A). Turning to FIG. 2B, the user first selects the object OB1. After the object OB1 is selected, the label LB1 attached to the object OB1 shown on the display panel 140 is highlighted. In some embodiments, the solid-line box represents a highlighted label after the corresponding object is selected by the user. However, the present disclosure is not limited thereto. For example, in some other embodiments, boxes shown in different colors may be used to distinguish the selected objects from the unselected objects.

After the object OB1 is selected by the user, the first image-sensing module 110 is configured to track and focus on the object OB1 to capture a first image IMG1.

For the embodiments illustrated in FIG. 2C, the user then selects the object OB2. After the object OB2 is selected, the label LB2 attached to the object OB2 shown on the display panel 140 is highlighted. After the object OB2 is selected by the user, the second image-sensing module 120 is configured to track and focus on the object OB2 to capture a second image IMG2.

The first image-sensing module 110 and the second image-sensing module 120 respectively transmit the first image IMG1 and the second image IMG2 to the processor 130. The processor 130 is further configured to fuse the first image IMG1 and the second image IMG2 into the resulting image IMGF. In some embodiments, the processor 130 transmits the resulting image IMGF to the display panel 140 for displaying.

Before the processor 130 fuses the first image IMG1 and the second image IMG2, the processor 130 performs calibration and cropping to align the view angles of the first image IMG1 and the second image IMG2. Because the first image-sensing module 110 and the second image-sensing module 120 may not be implemented at exactly the same position, there may be a difference between their view angles.

After the view angles of the first image IMG1 and the second image IMG2 are aligned, the processor 130 fuses the first image IMG1 and the second image IMG2 into the resulting image IMGF. In some embodiments, the fusing operation includes: constructing a depth map from the sensed scene; and fusing the first image IMG1 and the second image IMG2 according to the depth map. More specifically, the processor 130 is configured to construct the depth map from the scene being photographed. In some embodiments, the depth map is constructed using the first image-sensing module 110 and the second image-sensing module 120 based on a stereogram principle. In other embodiments, the depth map may be constructed using an additional TOF (Time of Flight) sensor of the image-capturing system 100. The processor 130 performs a subject fusion algorithm to fuse the first image IMG1 and the second image IMG2 according to the depth map to generate the resulting image IMGF. For example, the processor 130 may determine which regions (or objects) in the first image IMG1 may be out of focus according to the focus point and the depth map, and determines whether to replace image data of such regions (or objects) with corresponding image data that appears acceptably sharp in the second image IMG2. However, the present disclosure is not limited thereto. In various embodiments, the processor 130 performs the above operations further according to the lens position of the first image-sensing module 110.

In some embodiments, when the processor 130 detects the objects in the scene, the depth map is also produced to aid in distinguishing the edges of the objects. In other words, the depth map has been generated already and may contain useful information when the processor 130 starts performing the fusion operation. Consequently, the processor 130 may not have an excessive workload during the fusion operation since the depth map has already existed.

Because the object OB1 is tracked and focused on by the first image-sensing module 110, the object OB1 appears sharp and clear in the first image IMG1 while other objects in the first image IMG1 may be out of focus. In various embodiments, the other objects in the first image IMG1 apart from the focused object OB1 can be in or out of focus depending on the aperture of the first image-sensing module 110, the distance between the objects and the first image-sensing module 110, and the view angle of the first image-sensing module 110. Similarly, the second image IMG2 shows the object OB2 in focus, and other objects may be out of focus and appear unsharp in the second image IMG2.

The processor 130 fuses the first image IMG1 and the second image IMG2 into the resulting image IMGF. As illustrated in FIG. 3, the object OB1 and the object OB2 in the resulting image IMGF are in focus and sharp.

In other embodiments, the scene may include more than two objects OB1 and OB2, and the user may select more than two objects (such as three objects of interest) from the detected objects to be tracked and focused on. In such embodiments, the image-capturing system 100 further includes a third image-sensing module 150, and the third image-sensing module 150 is configured to track and focus on a third object to capture an image IMG3. The third image-sensing module 150 is similar to the second image-sensing module 120. Therefore, details associated with the third image-sensing module 150 are omitted herein for brevity. After the third image IMG3 is captured, the processor 130 fuses the first image IMG1, the second image IMG2, and the third image IMG3 into the resulting image IMGF.

In alternative embodiments, the image-capturing system 100 further includes more image-sensing modules for tracking and focusing on more objects of interest to generate additional images. The processor 130 further fuses all images generated by the image-sensing modules into the resulting image IMGF that gets multiple objects of interest all in focus.

In some embodiments, the display panel 140 is a touchscreen. The user can select the object of interest by touching a region on the display panel 140 coinciding with the label of that object. After the user selects the object of interest by touching the display panel 140, the processor 130 picks the object corresponding to the touched label. For example, when the user touches a region coinciding with the label LB1, the processor 130 picks the object OB1 and orders the first image-sensing module 110 to track and focus on the object OB1 to capture the first image IMG1.

The process of selecting the object by touching the display panel 140 is described for illustrative purposes and is not intended to be limiting. It should be appreciated that the user can use other methods to select the object of interest. For example, in various embodiments, the image-capturing system 100 further includes a user-sensing module 160 for sensing the user's selecting actions.

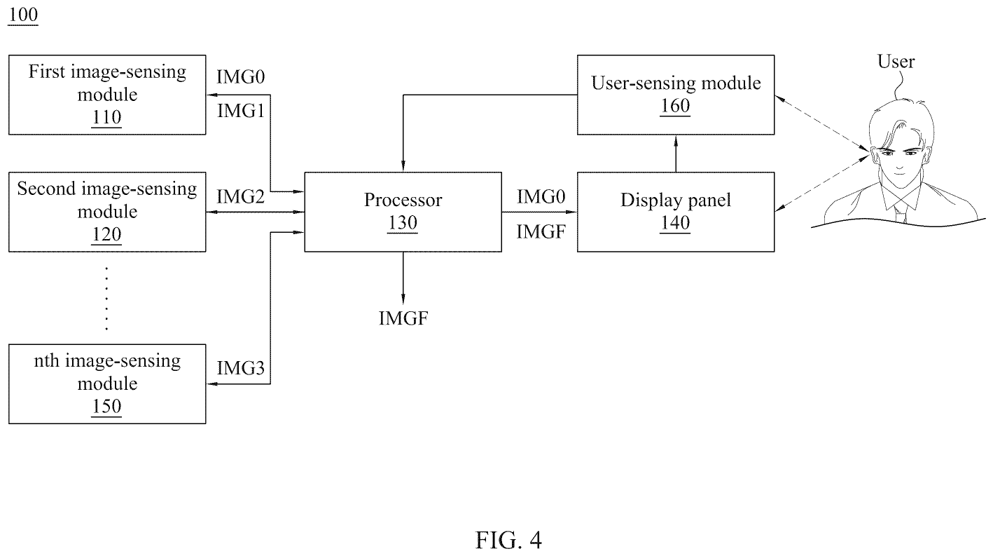

With reference to FIG. 4, the image-capturing system 100 includes the user-sensing module 160 coupled to the processor 130. In some embodiments, the user can select the object of interest by gazing at a region coinciding with the label of the object of interest shown on the display panel 140, and the user-sensing module 160 is configured to detect a gazed region at which the user is looking on the display panel 140. The processor 130 is further configured to pick the object when the user is looking at the region coinciding with the label of the object.

In other embodiments, a user can select the object of interest by making a vocal sound that may contain information linked to this object, such as a sound of the user speaking the phrase “label LB1.” The user-sensing module 160 is configured to detect the user's vocal sound. The processor 130 is further configured to translate the user's voice into user intent data and to pick the object with a label corresponding to the content of the user intent data.

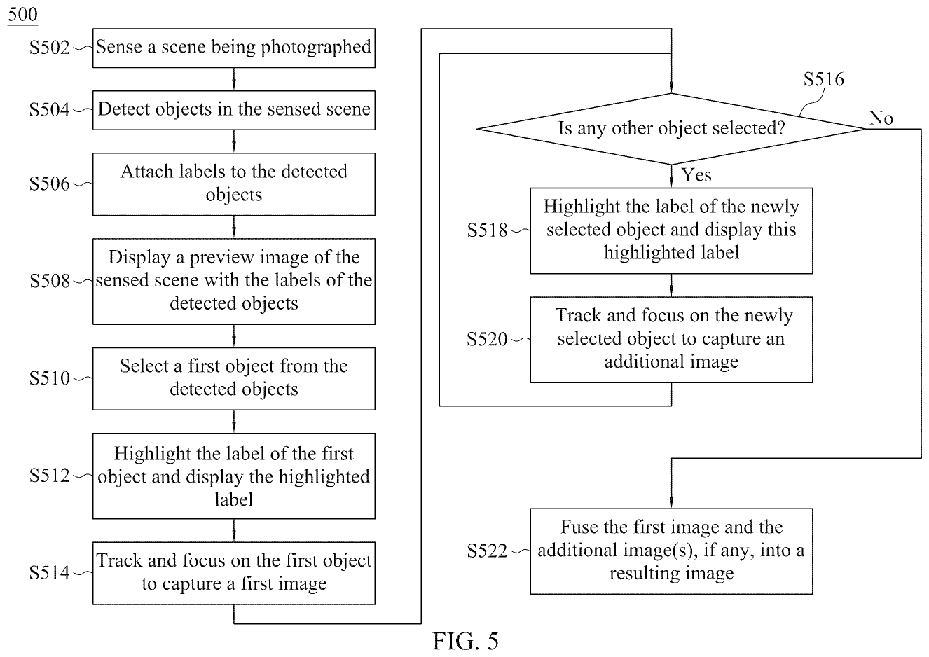

FIG. 5 shows a flow chart of an image-capturing method 500 according to some embodiments of the present disclosure. The image-capturing method 500 includes steps S502 to S522 and can be applied to the image-capturing system 100. In some embodiments, the first image-sensing module 110 and the second image-sensing module 120 may be cameras that include charge-coupled device (CCD) sensors or complementary metal-oxide semiconductor (CMOS) sensors for sensing lights reflected from objects in a scene.

In step S502, the first image-sensing module 110 operates to sense a scene that a user is photographing. In step S504, the processor 130 detects objects OB1 and OB2 in the scene sensed. In step S506, the processor 130 attaches the labels LB1 and LB2 to the detected objects OB1 and OB2, respectively. In step S508, the display panel 140 displays a preview image IMG0 of the sensed scene, which includes the labels LB1 and LB2 one-to-one attached to the objects OB1 and OB2. In step S510, for example, the user selects the object OB1 as the first object of interest from the detected objects OB1 and OB2. In step S512, the label LB1 is then highlighted, and the highlighted label LB1 is displayed on the display panel 140. In step S514, the first image-sensing module 110 tracks and focuses on the object OB1 to capture the first image IMG1. In step S516, it checks to see if the user selects any other object that he/she intends to focus on. If yes, the image-capturing method 500 proceeds to step S518. Otherwise, the image-capturing method 500 proceeds to step S522.

For example, in step S516, the user selects the object OB2 as a newly selected object of interest. Then, in step S518, the label LB2 of the object OB2 newly selected is highlighted on the display panel 140, and the highlighted label LB2 is displayed. In step S520, the second image-sensing module 120 tracks and focuses on the object OB2 newly selected to capture an additional image as the second image IMG2. According to some embodiments of the present disclosure, the first and the second image-sensing modules 110 and 120 capture the first image IMG1 and the second image IMG2 at the same instant substantially.

After step S520, the image-capturing method 500 goes back to step S516 again to check if the user further selects another object other than the first object OB1 and the second object OB2. If another object is selected, then steps S518 and S520 will be performed again. In this case, the third image-sensing module 150 may be used to track and focus on the newly selected object other than the objects OB1 and OB2. However, if no more object is selected, the image-capturing method 500 will enter step S522, and the processor 130 will fuse the first image IMG1 and the additional image(s), if any, into a resulting image IMGF. Taking FIG. 3 as an example, no more objects but the objects OB1 and OB2 are selected, so the first image IMG1 and the second image IMG2 are fused into the resulting image IMGF in which the objects OB1 and OB2 are both in focus. In addition, in some embodiments, to ensure that the first image IMG1 and the second image IMG2 can be fused even more smoothly, the first image IMG1 and the second image IMG2 are captured at the same instant substantially. However, the present disclosure is not limited thereto. In some embodiments, the first image IMG1 and the second image IMG2 may be captured at different time points but within a predetermined period.

Furthermore, in other embodiments, when the user only selects one object of interest (for example, only the object OB1 is selected), the image-capturing method 500 may not execute the image fusion process in step 522 and output the first image IMG1 as the resulting image IMGF.

In summary, the image-capturing system 100 and the image-capturing method 500 provided by the embodiments of the present disclosure allow a user to select more than one object of interest that he/she wants to focus on, thus producing in real time image/video having multiple objects in focus.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods or steps, presently existing or later to be developed, that perform substantially the same function or achieve substantially the same result as the corresponding embodiments described herein, may be utilized according to the present disclosure. Accordingly, the appended claims are intended to include within their scope such processes, machines, manufacture, compositions of matter, means, methods and steps.

What is claimed is:

1. An image-capturing system, comprising:
a first image-sensing module, configured to sense a scene that a user is photographing;
a second image-sensing module;
a processor, configured to detect a plurality of objects in the scene sensed by the first image-sensing module and to attach a plurality of labels to the detected objects; and
a display panel, configured to display a preview image of the sensed scene with the labels of the detected objects for the user to select,
wherein the first image-sensing module is further configured to track and focus on a first object of the detected objects selected by the user to capture a first image, and the second image-sensing module is configured to track and focus on a second object of the detected objects selected by the user to capture a second image,
wherein the processor is further configured to fuse the first image and the second image into a resulting image in which the first and the second objects are in focus.

2. The image-capturing system of claim 1, wherein the processor is further configured to construct a depth map from the scene being photographed, wherein the first image from the first image-sensing module and the second image from the second image-sensing module are fused into the resulting image according to the depth map.

3. The image-capturing system of claim 1, wherein the display panel is a touchscreen, and the processor is further configured to pick the first object when the user touches a region on the display panel coinciding with a label of the first object.

4. The image-capturing system of claim 1, further comprising:
a user-sensing module, configured to detect a gazed region on the display panel that the user is gazing at,
wherein the processor is further configured to pick the first object when the gazed region coincides with a label of the first object.

5. The image-capturing system of claim 1, further comprising:
a user-sensing module, configured to detect the user's vocal sound,
wherein the processor is further configured to translate the user's vocal sound into user intent data and pick the first object when the user intent data corresponds to a label of the first object.

6. The image-capturing system of claim 1, wherein the processor comprises an artificial intelligence (AI) processing unit, wherein the AI processing unit is configured to detect the objects in the preview image of the sensed scene according to a machine learning model.

7. The image-capturing system of claim 1, wherein the label of the first object shown on the display panel is highlighted after the first object is selected.

8. The image-capturing system of claim 1, wherein the processor is further configured to perform calibration and cropping to align view angles of the first and the second image-sensing modules.

9. The image-capturing system of claim 1, further comprising:
a third image-sensing module, configured to track and focus on a third object of the detected objects selected by the user to capture a third image,
wherein the processor is further configured to fuse the first image, the second image, and the third image into the resulting image in which the first, the second, and the third objects are all in focus.

10. The image-capturing system of claim 1, wherein the image-capturing system is implemented on a mobile phone or a dashboard camera.

11. An image-capturing method, comprising:
sensing a scene being photographed;
detecting a plurality of objects in the sensed scene;
attaching a plurality of labels to the detected objects;
displaying a preview image of the sensed scene with the labels of the detected objects on a display panel;
selecting a first object from the detected objects;
tracking and focusing on the first object to capture a first image;
selecting a second object from the detected objects;
tracking and focusing on the second object to capture a second image; and
fusing the first image and the second image into a resulting image in which the first and the second objects are in focus;
wherein the first image and the second image are captured at a substantially same instant.

12. The image-capturing method of claim 11, wherein the step of selecting the first object from the detected objects comprises:
detecting a region on the display panel at which a user is gazing; and
picking the first object when the gazed region coincides with a label of the first object shown on the display panel.

13. The image-capturing method of claim 11, wherein the step of selecting the first object from the detected objects comprises:
detecting a region on the display panel being touched by a user; and
picking the first object when the touched region coincides with a label of the first object shown on the display panel.

14. The image-capturing method of claim 11, wherein the step of selecting the first object from the detected objects comprises:
detecting a user's vocal sound;
translating the vocal sound to user intent data; and
picking the first object when the user intent data corresponds to a label of the first object.

15. The image-capturing method of claim 11, wherein the objects in the preview image of the sensed scene are detected according to a machine learning model.

16. The image-capturing method of claim 11, wherein the first image and the second image are fused according to a subject fusion algorithm.

17. The image-capturing method of claim 15, wherein the step of fusing the first image and the second image into the resulting image comprises:
constructing a depth map from the sensed scene; and
fusing the first image and the second image according to the depth map to generate the resulting image.

18. The image-capturing method of claim 11, further comprising:
selecting a third object from the detected objects; and
tracking and focusing on the third object to capture a third image,
wherein the first image and the second image are further fused with the third image to generate the resulting image in which the first, the second, and the third objects are all in focus.

19. The image-capturing method of claim 11, wherein the first image and the second image are captured using separate cameras of a single device, the method further comprising:
performing calibration and cropping to align view angles of the cameras.

20. The image-capturing method of claim 11, further comprising:
highlighting the label of the first object shown on the display panel after the first object is selected.
